(19) United States
(12) Patent Application Publication
(10) Pub. No.: US 2005/0244045 A1
(43) Pub. Date: Nov. 3, 2005

(54) Method and system for automatically improving the usability of a medical picture

(75) Inventor: Andreas Eriksson, Stockholm (SE)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: ELEKTA AB (PUBL), Stockholm (SE)

(21) Appl. No.: 11/116,345

(22) Filed: Apr. 28, 2005

Related U.S. Application Data
(60) Provisional application No. 60/572,950, filed on May 21, 2004.

(30) Foreign Application Priority Data
Apr. 30, 2004 (SE) 0401126-8

(51) Int. Cl. H05G 1/64

(52) U.S. Cl. 382/132

(57) ABSTRACT

A method of automatically improving the usability of a medical picture is disclosed. An input medical picture, comprising an array of intensity data, is improved by automatically controlling at least one intensity parameter, such as brightness or intensity, in order to increase the entropy of at least a part of the array of intensity data. Hereby, a remarkable improvement in the intensity resolution of various parts, especially in soft tissue, is achieved.

### FIELD OF THE INVENTION

The present invention relates to a method and a system for automatically improving the usability of a medical picture. Further, the invention relates to various uses of such a method.

### BACKGROUND OF THE INVENTION

Medical pictures and images find their use in a vast amount of different medical methods and therapies. For example, it is known to use medical images when preparing and conducting neurosurgical treatment of tumors, vascular deformities, and similar malformations in the brain. For this type of application, it is e.g. common to use a computer program, such as the commercially available GammaPlan program, which allows two or three dimensional viewing of target volumes and dose distribution as well as storage of lamina images of the brain that are obtained by imaging techniques such as computed tomography (CT), magnetic resonance imaging (MRI) and angiographic imaging, and in which the choice of irradiation points could be effected manually. It is also known to used automatized tools, e.g. a surgical planning system, such as the Leksell SurgiPlan. However, medical pictures are used in many other applications as well.

However, a common problem in assessing useful information from medical pictures, such as CT and MR pictures, is that the intensity range normally is very wide. For example, the intensity range for a CT image is typically about 4000 Hounsfields, ranging from air to parts with very high density, such as bone and skeleton parts, whereas the soft tissue normally is depictured in a very narrow intensity range, typically of about 100 Hounsfield, due to a smaller variation in density between these parts. However, for many types of surgery and therapy, the major or sole interest lies in the distinction between various parts of the soft tissue, and this could be very difficult from most medical pictures.

Accordingly, in order to deduce any medically useful information regarding the soft tissue from such a picture, it is of utmost importance to correctly control the intensity parameters of the pictures, and especially brightness and contrast, in order to delimit the gray scale window of the picture to a useful range. At the same time, it is important to control the intensity parameters in such a way that useful data is not lost. However, such an adequate control of the intensity parameters is a difficult, tedious and time consuming task, and requires high skills of the operator. The quality and usefulness of each picture is very much dependent on the individual skills of the operator in charge, leading to very varying results depending on the operator in charge. Further, the risks of human errors is high, with resulting difficulties for the physicians, and in the end increased health hazards for the patient to be treated.

Further, the quality and usefulness of the result provided by different tools using medical images as input, such as the above-discussed Gamma plan and Leksell SurgiPlan, are much dependent on the quality of the image information, and of the ability to distinguish between various soft tissue parts.

Still further, an often used technique in assessing useful and medically relevant information from medical images is to combine pictures, so called image merging or co-registration. This could be used in order to combine inter alia different types of pictures, e.g. CT and MR pictures. However, in order to provide correct co-registrations, a similarity metric must be computed, which requires that adequate intensity parameters for the images are known. Accordingly, also in this application it is of utmost importance to provide a good intensity resolution of the image parts of interest, e.g. parts corresponding to depicted soft tissue.

The same requirements apply to many other types of medically related picture analysis and picture manipulation, such as segmentation and pattern recognition.

Accordingly, there is a need for automatically improving the usability of a medical pictures.

### SUMMARY OF THE INVENTION

It is therefore an object of the present invention to provide a method, system and computer software for automatically improving the usability of medical pictures.

This object is achieved with a method, system and computer software according to the appended claims. The invention also relates to certain applications for use of this new method.

According to a first aspect of the invention, it relates to a method of automatically improving the usability of a medical picture, comprising the steps: providing as an input a medical picture, comprising an array of intensity data; automatically controlling at least one intensity parameter in order to increase the entropy of at least a part of the array of intensity data; and providing the processed array of intensity data as the improved medical picture.

With this method, the usability of medical pictures, such as CT and MR pictures, could be automatically improved. By the increase of the entropy in at least certain parts of the picture, the intensity resolution and possibility to distinguish between different parts of e.g. depictured soft tissue are greatly improved. However, the picture data is still maintained intact throughout the process, making the method medically reliable. Further, the method does not require any specific knowledge about the picture beforehand, regarding e.g. what object it depicts, how the image was made etc. On the contrary, the method provides an automatic improvement in the medical usability regardless of the input image, and without any additional information of the picture.

Further, apart from the above-discussed advantages, the method could also be implemented and executed very rapidly and cost effectively.

Since the improvement of the picture is performed automatically, no particular skills are required from the operator. Further, the end result is at least relatively independent on the operator, whereby a very reliable and secure end result is provided, thus alleviating the risk for human errors, and incurring no medical hazards for the patient.

Still further, the improved medical pictures also makes methods using such pictures more effective and more reliable.

In this application, medical picture is used as a denomination for any array of data representing a part of a human or animal body. The pictures could be presented for the user in various ways, e.g. by means of displays and print outs. Further, the pictures could be static or dynamic. E.g. the picture could be a depiction of the status at a particular time, or be continuously updated, preferably in real time.

Usability does in this application relate to a medical usefulness of the picture, and in particular to the usefulness in diagnostic or therapeutic applications.

Entropy is in this application a denomination for a measure or a quantification of the perceptual information content of an image, and preferably a digital image. For an estimation of the entropy for this application, the information entropy estimation theory introduced by C. Shannon could be used. A greater entropy value corresponds with a greater perceptual information content in the picture.

The entropy H[X] could be described as “the uncertainty in X”, not to be confused with posteriori or conditional entropy H[X/Y], which could be described as “the uncertainty in X provided knowledge of Y”.

In a preferred embodiment, the present invention uses entropy to find an intensity range for a picture, which e.g. could comprise three or more modes. This could be done by determining the entropy for a sub-range of the total intensity area. The resulting picture preferably comprises the sub-range which provides the largest entropy, or which is related to this sub-range. Thus, the entropy is calculated for a sub-range of the total intensity range for the picture, and when the sub-range is delimited, the resolution is increased within this sub-range, resulting in an increased uncertainty/entropy (thus providing more information to the observer of the output picture). At the same time, for the picture content falling outside this sub-range the uncertainty/entropy will be decreased. Thus, the entropy is used to balance these two effects.

The input medical picture is preferably generated by at least one of computed tomography (CT), magnetic resonance imaging (MRI), angiographic imaging, x-ray imaging, positron emission tomography (PET), single photon emission computerized tomography (SPECT), functional magnetic resonance imaging (fMRI) and ultrasonic imaging.

The at least one intensity parameter to be automatically controlled is preferably at least one of brightness and contrast, and most preferably both.

Further, the intensity parameter(s) to be automatically controlled is preferably controlled in order to reduce the gray scale window of said array of intensity data. For example, the grey scale window of a CT image may be controlled to a range of less than 500 Hounsfield, and preferably less than 250 Hounsfield, and most preferably about 100 Hounsfield.

The functional result of reducing the grey scale is to increase the dynamic range of a picture area. Consequently, a picture area with very limited color variations, e.g. varying within a range from dark grey to light grey, will, as the grey scale is reduced, be expanded into a much larger dynamic range, varying e.g. between total black and total white, and every nuance there between.

However, the intensity parameters to be controlled could be any parameters that affects the intensity data values in the array of intensity data. Said intensity parameters could preferably affect the brightness and/or the contrast directly or indirectly, e.g. by controlling the gray scale window.

Hounsfield is in this application used as a denomination of a normalized index of radiation (e.g. x-ray) attenuation, based on a scale of about −1000 (air) to about +1000 (bone), with water being 0, used in particular for CT imaging

The at least one intensity parameter is preferably automatically controlled in order to optimize the entropy of said at least a part of the array of intensity data. However, it is also possible to automatically increase the entropy until a certain condition is met. For example, the entropy could be increased so that a threshold value is exceeded. Further, the entropy could be controlled in order to be slightly less than the maximally achievable value, such as 90% of the maximum value.

The optimization of the entropy could also be made under the prerequisite that one or several other requirements are fulfilled. For example, the entropy may be optimized under the secondary requirement that the gray scale window is at least of a certain range, or does have a lower limit less than a certain value and/or an upper limit higher than a certain value.

Most preferably, the entropy of said at least a part of the array of intensity data is optimized by maximizing or essentially maximizing the entropy E, i.e. max [E], the entropy being estimated as:

$$E = - {\sum }_{i = 1}^{N} {{H}_{I} ( w )}_{i} log {{H}_{I} ( w )}_{i}$$

wherein H₁(w)_{1 . . . N} for 1 . . . N is the histogram of a picture I(x) computed for the intensity parameters w, and N is the number of bins in the histogram.

The above-defined estimate of the entropy corresponds to the Shannon concept of entropy. However, other entropy concepts may be used as well. E.g. the Rényi entropy concept may be used, whereby the entropy E could be estimated as:

$${E}_{α} = \frac{1}{1 - α} ln {\sum }_{i = 1}^{N} {{H}^{α} ( w )}_{i}$$

Another possibility is to use the Havrda-Charvat concept of entropy, based on which the entropy in the present invention could be estimated as:

$${E}_{α} = \frac{1}{1 - α} ( {\sum }_{i = 1}^{N} {{H}^{α} ( w )}_{i} - 1 )$$

Preferably, N in the entropy definitions above is chosen to be the number of gray scale values required for the improved medical picture. This may e.g. be the number of grey scale values possible to reproduce on a certain media, such as on a certain display or printer to be used, or the number of gray scale values discernible with the human eye.

In the estimations of entropy above, w is preferably defined as having an upper value (upper) and lower value (lower), and wherein values I(x)<lower are assigned to bin H₁(w)₁ and values I(x)>upper are assigned to bin H_{N}(w)_{N}.

Preferably, the step of automatically controlling at least one intensity parameter is adapted to increase the entropy of a part of the array of intensity data corresponding to a certain subset of the depicted objects, and preferably corresponding to depicted structures of interest, such as soft tissue. Hereby, the intensity resolution of such selected, and medically important parts could be greatly increased. What parts to be selected could be made either automatically, or controlled manually. However, it is also possible to control the intensity parameters in order to increase the overall entropy of the picture.

According to another aspect of the invention, it relates to a system for automatically improving the usability of a medical picture, comprising: input means for providing a medical picture, comprising an array of intensity data; means for automatically controlling at least one intensity parameter in order to increase the overall entropy of the array of intensity data; and output means for providing the thus improved array of intensity data as the improved medical picture.

With this aspect of the invention, similar advantages as discussed above in relation to the first aspect are provided.

According to another aspect of the invention, it relates to a computer program for automatically improving the usability of a medical picture, comprising computer code for executing the steps: providing as an input a medical picture, comprising an array of intensity data; automatically controlling at least one intensity parameter in order to increase the overall entropy of the array of intensity data; and providing as the thus improved array of intensity data as the output medical picture. According to still another aspect of the invention, it relates to a data carrier comprising the computer program discussed above.

With these aspects of the invention, similar advantages as discussed above in relation to the first aspect are provided.

The invention also relates to a use of the above-discussed method for preparing medical pictures for various applications, e.g. for image processing, such as image merging or co-registration, segmentation or pattern recognition; for automized therapy treatment planning, and preferably for planning of neurosurgical treatment; and for real time monitoring and/or control during therapy, and preferably neurosurgical therapy.

These and other aspects of the invention will be apparent from and elucidated with reference to the embodiments described hereinafter.

### BRIEF DESCRIPTION OF THE DRAWINGS

For exemplifying purposes, the invention will be described in closer detail in the following with reference to embodiments thereof illustrated in the attached drawings, wherein:

FIG. 1 is a schematic overview of an embodiment of the method according to the invention;

FIG. 2 is a schematic overview of a process for estimating entropy of a medical picture according to an embodiment of the invention; and

FIG. 3-5 illustrates examples of pictures before and after processing according to the invention.

### DESCRIPTION OF PREFERRED EMBODIMENTS

The invention will be described in the following for exemplifying purposes in more detail by means of examples.

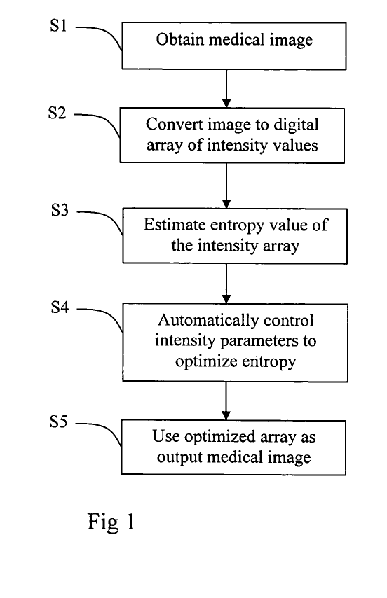

Referring first to FIG. 1, a method for automatically improving the usability of a medical picture according to one embodiment comprises the following steps. In a first step S1 a medical picture is input into a processing means, such as a computer, and preferably a conventional personal computer.

The medical picture is preferably a digital image comprising an array of intensity data. However, it is also possible to use analog medical pictures, whereby an additional conversion step S2 could be used for converting the analog picture information into a digital array of intensity data, as is per se known in the art. The picture could be provided in various ways, such as with CT and MR imaging, but essentially any known medical imaging technique could be used to obtain the input image. For example, it is also feasible to provide input images by means of angiography, x-ray imaging, PET, SPECT, fMRI and ultrasonic imaging.

Thereafter, the entropy of the digital image is estimated, step S3, in a way to be discussed more thoroughly in the following.

In an optimization step S4, at least one intensity parameter is thereafter automatically controlled in order to obtain a higher entropy value, and preferably to achieve the maximum achievable entropy value under the given circumstances. The intensity parameter controlled is preferably at least one of brightness and contrast, and most preferably both. However, as an alternative or complement, other intensity parameters may be controlled as well. The intensity parameters are preferably controlled in order to reduce the gray scale window of said array of intensity data. For example, the grey scale window of a CT image may be controlled to a range of less than 500 Hounsfield, and preferably less than 250 Hounsfield, and most preferably about 100 Hounsfield.

The optimized data array is subsequently used as the improved output medical picture, step S5.

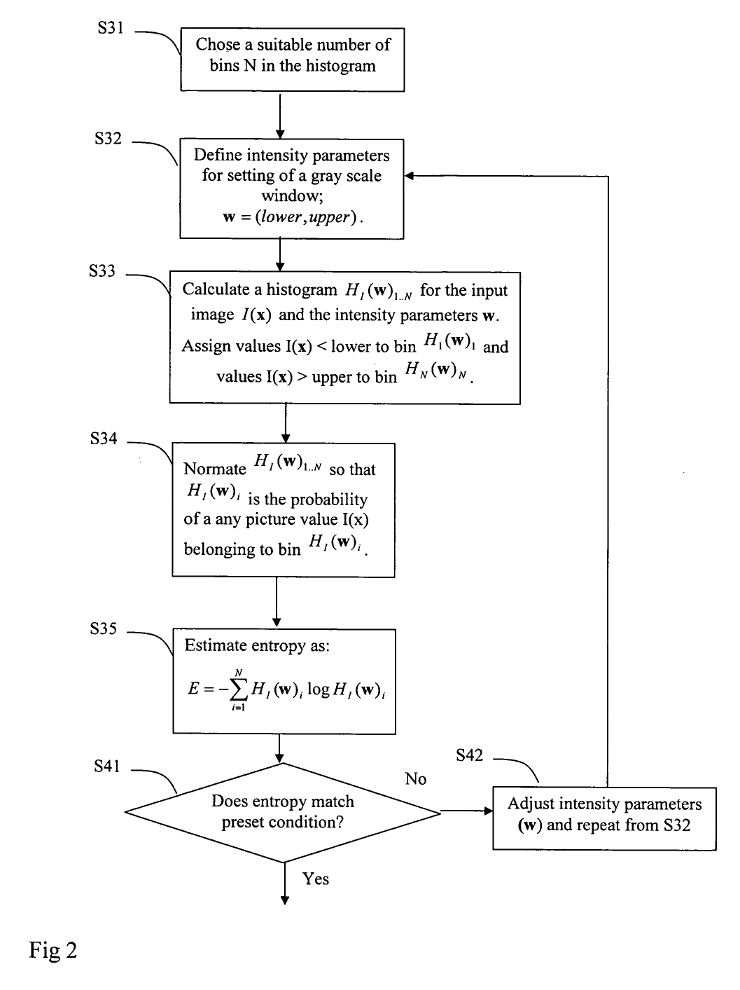

The process for estimation of the entropy and optimization of the intensity parameters will in the following be discussed more thoroughly, with reference to FIG. 2. Entropy is a measure of the information content in a picture or signal. Entropy is here discussed in regard of black-and-white pictures, but a similar approach may naturally be used for color pictures as well. The entropy E could be defined in various ways. E.g. the Shannon definition of entropy could be used. If so, the estimation of the entropy of a medical picture could be made in the following way:

First, the number of bins N in the histogram is chosen, step S31. Preferably N is chosen to correspond to the number of gray scale values which could be presented by the presentation means to be used, such as a display or a printer, or which the eye is capable of resolving. An initial set of intensity parameters w=(lower, upper) are defined, step S32. The intensity parameters are subsequently controlled in order to optimize the entropy, as discussed in the foregoing. A histogram H₁(w)_{1 . . . N} is then computed for the input image I(x) and the intensity parameters w, wherein values I(x)<lower are assigned to bin H₁(w)₁ and values I(x)>upper are assigned to bin H_{N}(w)_{N} (step S33).

Then, H₁(w)_{1 . . . N} is normated, step S34, so that H₁(w)ᵢ is the probability of a any picture value I(x) belonging to that bin.

The entropy could then be calculated (step S35) as:

$$E = - {\sum }_{i = 1}^{N} {{H}_{I} ( w )}_{i} log {{H}_{I} ( w )}_{i}$$

It is then tested whether the entropy match a certain condition, such as being optimized, being at least 90% of the optimally achievable, being above a certain pre-set value, or the like (step S41). If not, the w is adjusted, and the process is repeated from step S32 (step S42).

For the automatic control of the intensity values as discussed in the foregoing, the gray scale window I(w) is preferably optimized in order to maximize the entropy E. This optimization process could be performed in many different ways. For example, it is possible to calculate the entropy for every possible value of the intensity parameter to be controlled, or for every possible combination of values in case several parameters are controlled simultaneously, and to chose the parameter value(s) providing the highest entropy. However, it is also possible to use various optimization algorithms, such as iterative optimization methods. Several such automated optimization methods are per se known in the art. For example, it is possible to use one or several of the following optimization methods: simulated annealing, evolutionary algorithms, genetic algorithms, simplex methods, direction-set methods, conjugate gradient method and quasi-Newton methods.

The method as discussed above could preferably be implemented as a computer program comprising computer code for executing the above-related steps. The computer program could be stored on any type of data carrier, such as a RAM, ROM, CD, DVD, flash memory, etc.

The method could be executed on a data processing apparatus, such as a general purpose computer, with input means for inputting a medical picture. The input means could be a reader for extracting data from a mobile data storage, such as a disc reader, a scanner, a network connection, a port to be connected to an imaging device, or the like. Further, the apparatus is also provided with output means for providing the improved array of intensity data as the improved medical picture. The output device could comprise a display, a printer, a writer for storing data on in a data storage, and preferably a mobile data storage, such as a CD-ROM writer, or the like. The image data processing could preferably be implemented in software, but it is also possible to implement at least some part of it in especially dedicated hardware. Further, it the above-discussed parts may be contained within a single unit, or comprise distributed, interconnected parts. The method could, however, also be implemented in special equipment, such as in an ultrasonic apparatus, x-ray equipment, and the like.

The output medical pictures, resulting from the above-discussed method, may be used in various applications, and especially for different types of automatized or manual therapy and diagnostic methods. For example, the output picture could be used for controlling stero-tactic surgery equipment, such as the one disclosed in WO 00/42928 by the same applicant, said reference hereby incorporated by reference. Hereby, the output picture could be used for measuring the destroyed volume of tissue during the lesion process. However, new method is also useful for other types of surgical procedures, and especially for neurosurgery, e.g. for real time monitoring and/or control during said therapy.

The above discussed method for improving the usability of medical pictures is also particularly useful for preparing pictures to be used in automatized therapy treatment planning, and preferably for planning of neurosurgical treatment, as discussed in WO 98/57705 by the same applicant, said reference hereby incorporated by reference.

The improved medical pictures could also be used in other types of applications, such as for preparing pictures for other types or automated methods. E.g. said pictures could be used for preparing medical pictures for image processing, such as image merging or co-registration, segmentation or pattern recognition.

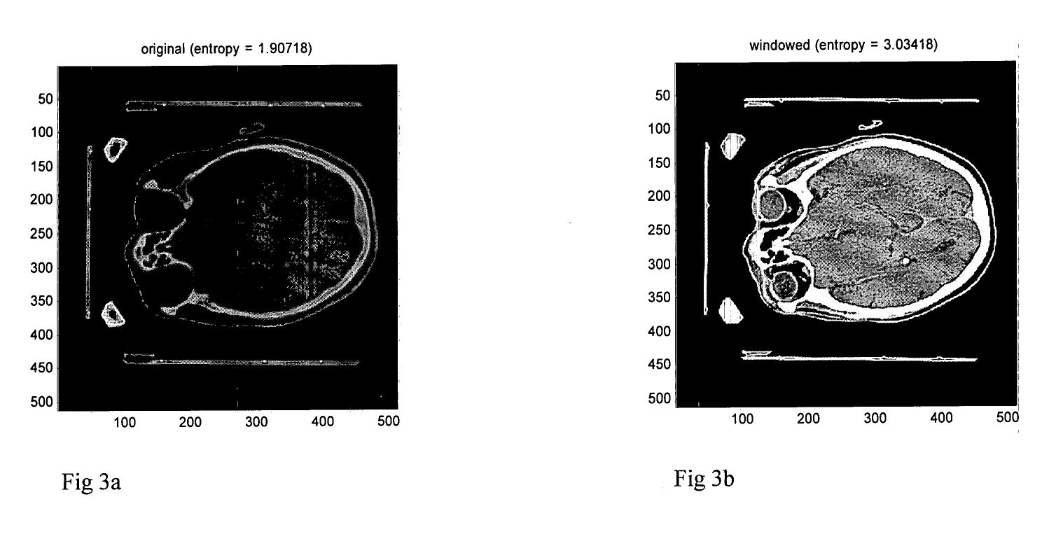

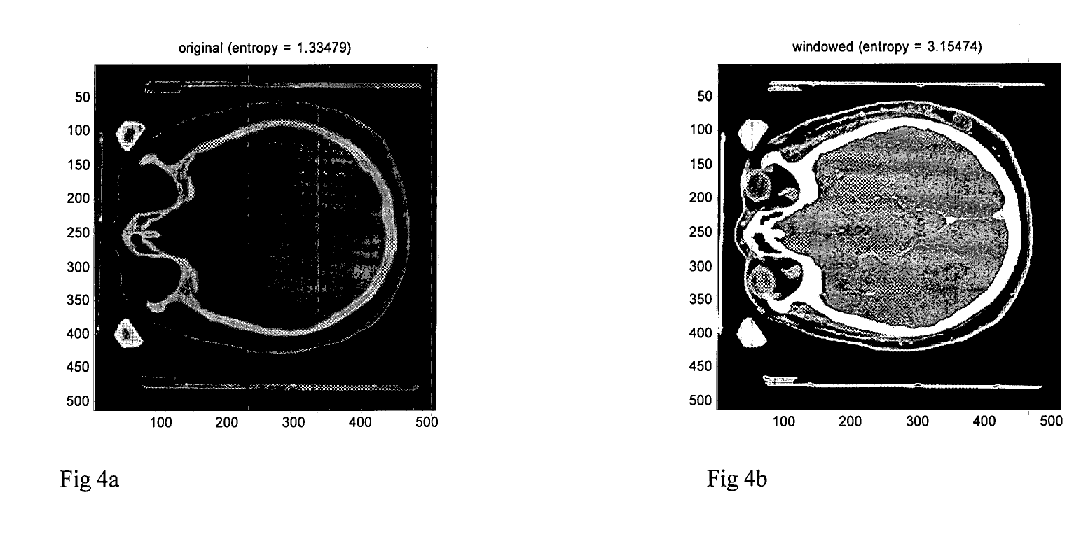

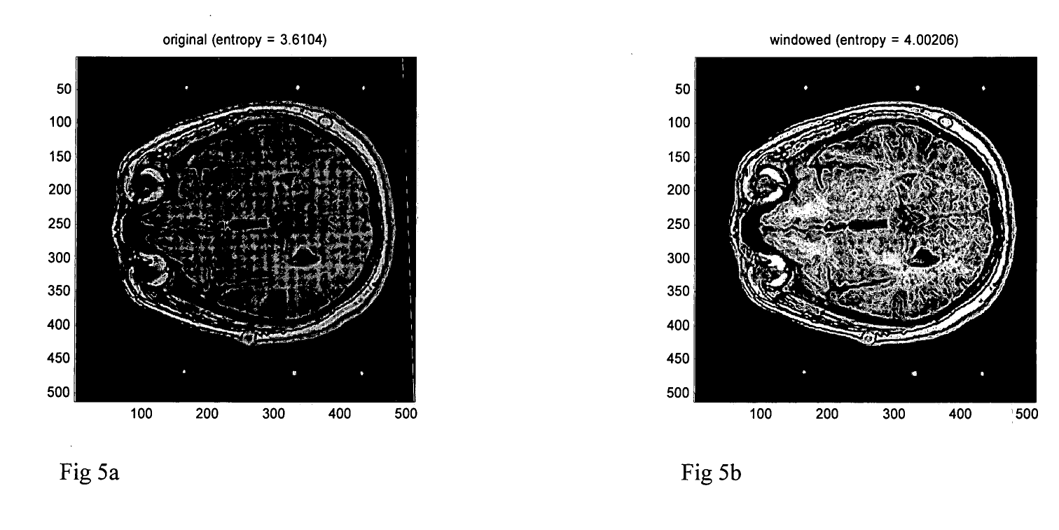

In FIG. 3-5 examples of the use of the present invention are provided. In FIG. 3a an input image is illustrated, having an original entropy of 1.907. After being processed as discussed above, an output image is obtained, as illustrated in FIG. 3b, having an entropy of 3.034, and consequently with a clearly enhanced visibility and intensity resolution of the soft tissue portions. Similarly, FIG. 4a illustrates an input image having an original entropy of 1.335, and FIG. 4b illustrates an improved image having an entropy of 3.155. In FIG. 5a, the input image has an original entropy of 3.610, whereas the improved image has an entropy of 4.002.

Specific embodiments of the invention have now been described. However, several alternatives are possible, as would be apparent for someone skilled in the art. For example, various ways to estimate entropy are feasible, the optimization could be performed in many different ways, etc.

Such and other obvious modifications must be considered to be within the scope of the present invention, as it is defined by the appended claims. It should be noted that the above-mentioned embodiments illustrate rather than limit the invention, and that those skilled in the art will be able to design many alternative embodiments without departing from the scope of the appended claims.

1. Method of automatically improving the usability of a medical picture, comprising the steps:
providing as an input a medical picture, comprising an array of intensity data;
automatically controlling at least one intensity parameter in order to increase the entropy of at least a part of the array of intensity data; and
providing the processed array of intensity data as the improved medical picture.

2. The method of claim 1, wherein the at least one intensity parameter to be automatically controlled is at least one of brightness and contrast.

3. The method of claim 1, wherein the at least one intensity parameter to be automatically controlled is controlled in order to reduce the gray scale window of said array of intensity data.

4. The method of claim 3, wherein the grey scale window is controlled to a range of less than 500 Hounsfield.

5. The method of claim 1, wherein the at least one intensity parameter is automatically controlled in order to optimize the entropy of said at least a part of the array of intensity data.

6. The method of claim 5, wherein the entropy of said at least a part of the array of intensity data is optimized by maximizing or essentially maximizing the entropy E, i.e. max [E], the entropy being estimated as:
$$E = - {\sum }_{i = 1}^{N} {{H}_{I} ( w )}_{i} log {{H}_{I} ( w )}_{i}$$
wherein H₁(w)_{1 . . . N} is the histogram of the picture I(x) computed for the intensity parameters w, and N is the number of bins in the histogram.

7. The method of claim 6, wherein N is chosen to the number of gray scale values required for the improved medical picture.

8. The method of claim 6, wherein w is defined as having an upper value (upper) and lower value (lower), and wherein values I(x)<lower are assigned to bin H₁(w)₁ and values I(x)>upper are assigned to bin H_{N}(w)_{N}.

9. The method of claim 1, wherein the input medical picture is generated by at least one of computed tomography (CT), magnetic resonance imaging (MRI), angiographic imaging, x-ray imaging, positron emission tomography (PET), single photon emission computerized tomography (SPECT), functional magnetic resonance imaging (fMRI), and ultrasonic imaging.

10. The method of claim 1, wherein the step of automatically controlling at least one intensity parameter is adapted to increase the entropy of a part of the array of intensity data corresponding to a certain subset of the depicted objects.

11. A system for automatically improving the usability of a medical picture, comprising:
input means for providing a medical picture, comprising an array of intensity data;
means for automatically controlling at least one intensity parameter in order to increase the entropy of at least a part of the array of intensity data; and
output means for providing the thus improved array of intensity data as the improved medical picture.

12. The system of claim 11, wherein the at least one intensity parameter to be automatically controlled is at least one of brightness and contrast.

13. The system of claim 11, wherein the means for controlling the at least one intensity parameter is adapted to control said parameters in order to reduce the gray scale window of said array of intensity data.

14. The system of claim 11, wherein the means for controlling the at least one intensity parameter is adapted to control said parameters in order to optimize the entropy of said at least a part of the array of intensity data.

15. The system of claim 11, wherein the input medical picture is generated by at least one of computed tomography (CT), magnetic resonance imaging (MRI), angiographic imaging, x-ray imaging, positron emission tomography (PET), single photon emission computerized tomography (SPECT), functional magnetic resonance imaging (fMRI), and ultrasonic imaging.

16. A computer program for automatically improving the usability of a medical picture, comprising computer code for executing the steps:
providing as an input a medical picture, comprising an array of intensity data;
automatically controlling at least one intensity parameter in order to increase the entropy of at least a part of the array of intensity data; and
providing as the thus improved array of intensity data as the output medical picture.

17. A data carrier for storing a computer program according to claim 16.

18. The method according to claim 1, wherein medical pictures for image processing are prepared.

19. The method according to claim 1, wherein medical pictures for automized therapy treatment planning, are prepared.

20. The method according to claim 1, wherein medical pictures for real time monitoring and/or control during therapy, are prepared.

21. The method of claim 2, wherein the at least one intensity parameter to be automatically controlled is controlled in order to reduce the gray scale window of said array of intensity data.

22. The method of claim 2, wherein the at least one intensity parameter is automatically controlled in order to optimize the entropy of said at least a part of the array of intensity data.

23. The method of claim 3, wherein the at least one intensity parameter is automatically controlled in order to optimize the entropy of said at least a part of the array of intensity data.

24. The method of claim 21, wherein the at least one intensity parameter is automatically controlled in order to optimize the entropy of said at least a part of the array of intensity data.

25. The method of claim 7, wherein w is defined as having an upper value (upper) and lower value (lower), and wherein values I(x)<lower are assigned to bin I(w), and values I(x)>upper are assigned to bin H_{N}(w)_{N}.

26. The system of claim 12, wherein the means for controlling the at least one intensity parameter is adapted to control said parameters in order to reduce the gray scale window of said array of intensity data.

27. The system of claim 12, wherein the means for controlling the at least one intensity parameter is adapted to control said parameters in order to optimize the entropy of said at least a part of the array of intensity data.

28. The system of claim 13, wherein the means for controlling the at least one intensity parameter is adapted to control said parameters in order to optimize the entropy of said at least a part of the array of intensity data.

29. The system of claim 26, wherein the means for controlling the at least one intensity parameter is adapted to control said parameters in order to optimize the entropy of said at least a part of the array of intensity data.

30. The system of claim 12, wherein the input medical picture is generated by at least one of computed tomography (CT), magnetic resonance imaging (MRI), angiographic imaging, x-ray imaging, positron emission tomography (PET), single photon emission computerized tomography (SPECT), functional magnetic resonance imaging (fMRI), and ultrasonic imaging.

31. The system of claim 13, wherein the input medical picture is generated by at least one of computed tomography (CT), magnetic resonance imaging (MRI), angiographic imaging, x-ray imaging, positron emission tomography (PET), single photon emission computerized tomography (SPECT), functional magnetic resonance imaging (fMRI), and ultrasonic imaging.

32. The system of claim 14, wherein the input medical picture is generated by at least one of computed tomography (CT), magnetic resonance imaging (MRI), angiographic imaging, x-ray imaging, positron emission tomography (PET), single photon emission computerized tomography (SPECT), functional magnetic resonance imaging (fMRI), and ultrasonic imaging.
